(19) United States
(12) Patent Application Publication
(10) Pub. No.: US 2004/0194137 A1
(43) Pub. Date: Sep. 30, 2004

(54) Method, system, and apparatus for aural presentation of program guide

(76) Inventor: Vasanth Shreesha, Maple Shade, NJ (US)

Correspondence Address: RATNERPRESTIA, P O BOX 980, VALLEY FORGE, PA, 19482-0980, US

(21) Appl. No.: 10/400,088

(22) Filed: Mar. 26, 2003

(51) Int. Cl. H04N 5/445; G06F 3/00; G06F 13/00

(52) U.S. Cl. 725/41; 725/39

(57) ABSTRACT

A method, apparatus, and system for presenting program guide content in an audio format is disclosed. The program guide content is presented by receiving a program guide and a program having an audio component, aurally presenting the audio component at one of at least two audio output devices, and aurally presenting the program guide at an other one of the at least two audio output devices concurrently with the aural presentation of the audio component.

### FIELD OF THE INVENTION

The present invention relates to the field of electronic program guides and, more particularly, to methods, systems, and apparatus for aurally presenting program guide content.

### BACKGROUND OF THE INVENTION

Electronic program guides (EPGs) are currently available that contain content such as television schedule information for most television sources, e.g., broadcast, cable, and satellite. An EPG is typically transmitted through a Vertical Blanking Interval (VBI) of an NTSC television signal or on a separate channel, e.g., an out-of-band channel. Presently, many television receivers, such as those found in set-top boxes or televisions, are able to receive and decode the transmitted EPG for visual presentation on a video display associated with the television receiver. The content of the EPG is typically presented at the request of a single viewer in a video format that obscures at least a portion of the video display. In many EPGs, the viewer is able to scan the content of the EPG and tune to a program of interest by selecting the program from the presented content with a remote control.

Many television viewers are distracted by the visual presentation of EPG content, which diminishes the viewing enjoyment of these viewers. The visual presentation is especially annoying to a viewer that did not request the EPG content. For example, if multiple viewers are watching a television program and one of the viewers requests EPG content, all viewers are subjected to the visual disruption created by the EPG content regardless of whether they desire EPG content or not.

One system for addressing the problem of an obscured video display when presenting EPG content involves aurally presenting the EPG content. In these systems, the EPG content is converted to an audio signal and then either replaces the audio component of a program or is mixed with the audio component of the program. Such a system is described in U.S. Pat. No. 6,020,880 to Naimpally entitled METHOD AND APPARATUS FOR PROVIDING ELECTRONIC PROGRAM GUIDE FROM A SIGNAL ELECTRONIC PROGRAM GUIDE SERVER, which is commonly assigned to the same entity as the present application. The EPG content in this type of system obscures at least a portion of the audio component of a program. Many television viewers are distracted by the audio presentation of the EPG content, which diminishes their enjoyment of the program, and is especially annoying to a viewer that is subject to the audio disruption created by the EPG content regardless of whether they requested the EPG content or not.

Accordingly, less disruptive methods, systems, and apparatus are needed for presenting EPG content. The present invention fulfills this need among others.

### SUMMARY

The present invention provides a method, apparatus, and system for aurally presenting program guide content. The present invention satisfies the aforementioned need by aurally presenting the program guide at one audio output device and aurally presenting the audio component of a program at an other audio output device. By presenting the program guide at one audio output device and the audio component at another audio output device, the program guide may be aurally presented to a viewer requesting the program guide without disrupting the audio or video component of a program being enjoyed by other viewers. Accordingly, presentation of the program guide does not diminish viewing enjoyment for these other viewers.

The method includes receiving, at a receiver, a program guide and a program having an audio component, aurally presenting the audio component at one of at least two audio output devices; and aurally presenting the program guide at an other one of the at least two audio output devices concurrently with the aural presentation of the audio component.

The system includes means for receiving, at a receiver, a program guide and a program having an audio component, means for aurally presenting the audio component at one of at least two audio output devices, and means for aurally presenting the program guide at an other one of the at least two audio output devices concurrently with the aural presentation of the audio component.

The apparatus includes a receiver configured to receive a program guide and an audio component, and at least two audio output devices configured to aurally present the program guide and the audio component concurrently. The at least two audio output devices configured to couple to the receiver such that one of the at least two audio output devices aurally presents one of the program guide and the audio component and an other one of the at least two audio output devices aurally presents the other of the program guide and the audio component.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of an apparatus for aurally presenting program guide content in accordance with an exemplary embodiment of one aspect of the present invention;

FIG. 2 is a block diagram of a remote control device for use with the apparatus of FIG. 1; and

FIG. 3 is a flow chart depicting an exemplary method for configuring and navigating an aural program guide in accordance with one aspect of an exemplary embodiment of the present invention.

### DETAILED DESCRIPTION OF THE INVENTION

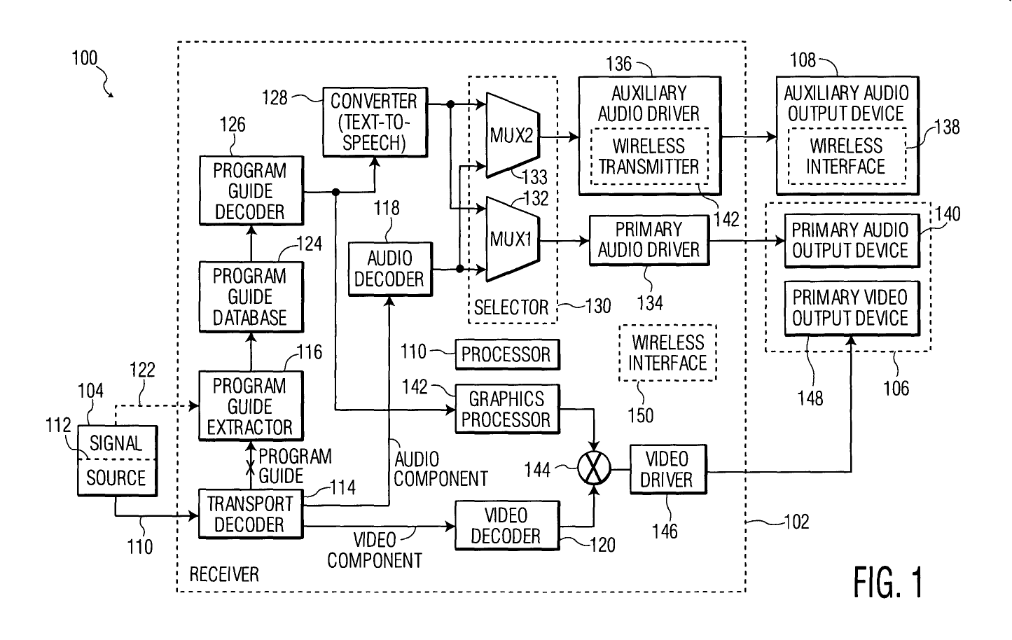

FIG. 1 depicts an exemplary apparatus 100 for aurally presenting program guide content in accordance with one aspect of the present invention. Generally, the apparatus 100 includes a receiver 102 for processing program and program guide signals received from a signal source 104, a primary output device 106 for aurally presenting either the audio component of the program or the program guide processed by the receiver 102, and an auxiliary audio output device 108 for aurally presenting the other one of the audio component or the program guide processed by the receiver 102. The apparatus 100 is now described in detail.

A processor 110 controls the receiver 102. In an exemplary embodiment, the processor 110 controls signal flow through the receiver 102. In addition, in certain exemplary embodiments, the processor 110 may perform the functions of one or more of the blocks illustrated in the receiver 102. Connection lines between the processor 110 and individual blocks illustrated in the receiver 102 of FIG. 1 are omitted to avoid confusion. The processor may be a conventional microcontroller, microprocessor, or digital signal processor; with suitable processors for use in the present invention being readily apparent to those of skill in the art of signal processing.

The signal source 104 supplies a program signal and a program guide signal to the receiver 102. In an exemplary embodiment, the program signal is an audio/video signal having an audio component and a video component, e.g., a television signal received from a signal source 104 such as a broadcast, satellite, or cable television system, personal video recorder (PVR), or digital versatile disc (DVD) player. In an alternative exemplary embodiment, the program signal is an audio signal having an audio component received from a signal source 104 such as a compact disc (CD) player or an MPEG-1 layer III (MP3) player.

The program guide signal is a signal representing program content such as television schedule information (e.g., an EPG signal) or the contents of media or internal databases on or within a DVD, CD, MP3, PVR, or other such device. In certain exemplary embodiments, the program guide signal is supplied by the same signal source 104 as the program signal. In other exemplary embodiments, a separate signal source (represented by dashed line 112) supplies the program guide signal. The program guide signal may be supplied through a variety of signal transmission means including the VBI of a program, out-of-band channels, telephone lines, the Internet, or essentially any wired or wireless connection capable of supporting signal transmission.

The receiver 102 receives the program signal and the program guide signal for processing. In embodiments where the program signal and the program guide signal are carried on a common signal, the program signal and the program guide signal are applied to a transport decoder 114. In accordance with this embodiment, the transport decoder 114 parses the common signal to separate the program signal and the program guide signal and to separate the program signal into components (e.g., an audio component and a video component). The transport decoder 114 then routes the separated signals for further processing. In the illustrated embodiment, the transport decoder 114 routes a program guide signal to a program guide extractor 116, routes an audio component to an audio decoder 118, and routes a video signal to a video decoder 120.

The program guide extractor 116 extracts the program guide from the program guide signal. In embodiments where the program signal and the program guide signal are carried on separate signals, the program guide signal is applied directly to the program guide extractor 116 (represented by dashed line 122). In accordance with these embodiments, the connection between the program guide extractor 116 and the transport decoder 114 is eliminated. In an exemplary embodiment, the program guide is contained within an MPEG data stream and the program guide extractor extracts the program guide using conventional MPEG processing techniques, which are well known to those of skill in the art.

The extracted program guide is stored in a program guide database 124. In an exemplary embodiment, the extracted program guide is stored in a text format. In certain exemplary embodiments, the program guide is obtained by the receiver 102 at predefined times. For example, the receiver 102 can be set to receive the program guide at a time when the receiver 102 is not in use, e.g., late at night or early in the morning. In an alternative exemplary embodiment, such as where the program guide is present continuously in the VBI of a received channel, the program guide database 124 may be continuously updated. In another alternative exemplary embodiment, the program guide is available essentially “on-demand,” thereby eliminating the need for the program guide database 124. It will be readily apparent to those of skill in the art that memory requirements for the program guide database 124 will depend on many factors including, by way of example, the content stored, the number of channels, and the period of time stored.

The program guide decoder 126 decodes the program guide for presentation to a user. In an exemplary embodiment, the program guide decoder 126 decodes the program guide to obtain information that is more meaningful to a user. For example, prior to decoding, the program information may be a condensed string of alphanumeric characters such as “030010730208002001 FAMILY FUED,” where the first five characters represent the Julian date (e.g., Jan. 1, 2003), the next five characters represent the start time with the fifth character representing 1=AM or 2=PM (e.g., 7:30 PM), the next five characters represent the end time (e.g., 8:00 PM), the next three characters represent the channel, and the remaining characters represent the title of the show. In this example, assuming that it is currently 6:00 PM on Jan. 1, 2003, the program guide decoder 124 may decode the alphanumeric characters as follows: “Tonight at 7:30 PM on channel 1—Family Feud with a runtime of 30 minutes.”

The decoded program guide is applied to a converter 128. The converter 128 converts the program guide to an audio signal. In an exemplary embodiment, the converter 128 is a text-to-speech converter. A suitable text-to-speech converter is described in U.S. Pat. No. 5,924,068 to Richard et al. entitled ELECTRONIC NEWS RECEPTION APPARATUS THAT SELECTIVELY RETAINS SECTIONS AND SEARCHES BY KEYWORD OR INDEX FOR TEXT TO SPEECH CONVERSION, which is commonly assigned to the same entity as the present application. In certain exemplary embodiments, the program guide is received at the receiver 102 in a suitable audio format, thereby eliminating the need for the program guide decoder 126 and converter 128.

The audio decoder 118 decodes the audio component from the transport decoder 112 into an audio signal. In an exemplary embodiment the audio decoder 118 is a conventional AC3 audio decoder.

A selector 130 routes the audio signals from the converter 126 and the audio decoder 118. In an exemplary embodiment, the selector 130 selects which of the audio signals from the converter 126 and audio decoder 118 is passed to a primary audio driver 134 and which is passed to an auxiliary audio driver 136. In the illustrated embodiment, the selector 130 includes a first multiplexer 132 and a second multiplexer 133. The selector 128 is responsive to a selection signal. In an exemplary embodiment, the processor 110 acts as a switch that generates the selection signal for configuring the selector 130.

In an exemplary embodiment, the selector 130 is configured in one of four modes responsive to the selection signal. In a first mode, the first multiplexer 132 passes the audio component from the audio decoder 118 to the primary audio driver 134 and the second multiplexer 133 passes the converted program guide from the converter 128 to the auxiliary audio driver 136. In a second mode, the first multiplexer 132 passes the converted program guide to the primary audio driver 134 and the second multiplexer 133 passes the audio component to the auxiliary audio driver 136. In a third mode, both the first multiplexer 132 and the second multiplexer 133 pass the audio component to the primary audio driver 134 and the auxiliary audio driver 136, respectively. In a fourth mode, both the first multiplexer 132 and the second multiplexer 133 pass the converted program guide to the primary audio driver 134 and the auxiliary audio driver 136, respectively.

The primary audio driver 134 and the auxiliary audio driver 136 configure the respective audio signals received from the selector 128 for aural presentation at an audio output device. In the illustrated embodiment, the primary audio driver 134 is coupled to a primary audio output device 140, e.g., a speaker, within the primary output device 106 and the auxiliary audio receiver is coupled to the auxiliary audio output device 108. In the illustrated embodiment, the auxiliary audio driver 136 includes a wireless transmitter 142 and the auxiliary audio output device 108 includes a wireless interface 138, thereby allowing the receiver 102 to wirelessly couple to the auxiliary audio output device 108. In an alternative embodiment, the auxilary audio output device 108 is coupled to the auxiliary audio driver using a wired connection, thereby eliminates the need for wireless transmitter 142 and wireless interface 138. It will be readily apparent to those of skill in the art that the primary and auxiliary audio drivers 134, 136 may be present in the receiver 102, their respective audio output device 140,108, or in between. The primary and/or auxiliary audio output devices 106, 108 may also be integrated with the receiver 102.

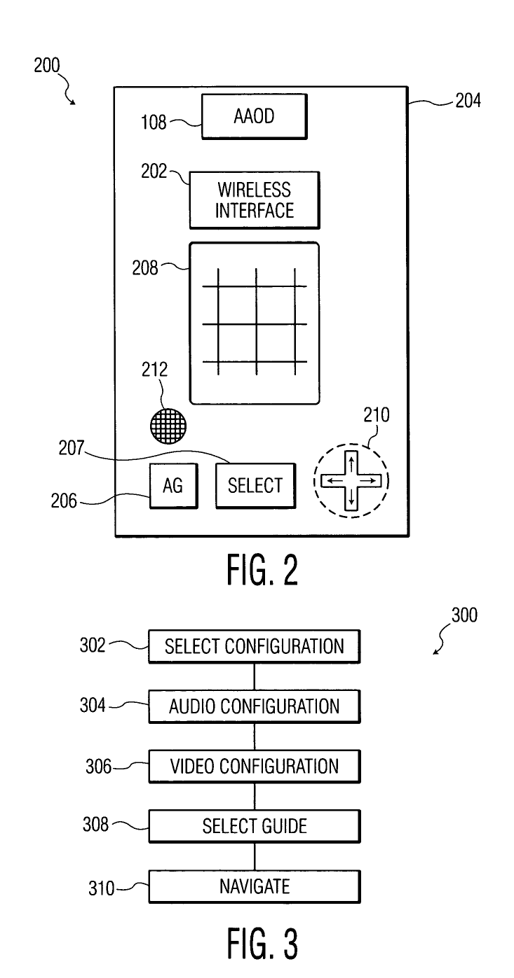

In an exemplary embodiment, the auxiliary audio output device 108 is physically coupled to the housing of a remote control (see FIG. 2). In alternative exemplary embodiments, the auxiliary audio output device is a wired or wireless device such as a wireless headset. Various alternative embodiments for the configuration of the auxiliary audio output device 108 will be readily apparent to those of skill in the art and are considered within the scope of the present invention.

In certain exemplary embodiments, the decoded program guide is also passed to a graphics processor 142. The graphics processor 142 processes the decoded program guide to generate a program guide video signal for visual display. The graphics processor 142 may be a conventional graphics processor such as a known “on-screen” display processor.

A mixer 144 mixes the video signals from the graphics processor 142 and the video decoder 120. In an exemplary embodiment, the program guide overlays at least a portion of the video component associated with a program. In certain exemplary embodiments, the selector 130 includes the mixer 144. In accordance with this embodiment, the selector 130 selectively configures the mixer 130 to visually present the program guide responsive to a selection signal produced by the processor 110 (for example). In certain exemplary embodiments, the program guide is suppressed so that it is not displayed. In certain other exemplary embodiments, the program guide is not visually presented, thus eliminating the need for the graphics processor 142 and the mixer 144.

A video driver 146 processes the mixed video signal in a known manner to drive a video output device such a conventional video display. In the illustrated embodiment, the video driver 126 is coupled to a primary video output device 148, e.g. a television display. It will be readily apparent to those of skill in the art that the video driver 126 may be present in the receiver 102, the video output device 106, or in between. The primary video output device 148 may also be integrated with the receiver 102.

A wireless interface 150 provides a wireless connection point for the receiver 102 that allows the receiver to communicate with other wireless devices, e.g., a remote control. The wireless interface 150 may communicate using infrared, radio, and/or other such signal mediums.

FIG. 2 depicts a remote control 200. The illustrated remote control 200 includes the auxiliary audio output device 108 and a wireless interface 202 for wireless communication with the receiver 102 (FIG. 1), e.g., through wireless interface 150 (FIG. 1). In an alternative embodiment, the remote control 200 is wired to the receiver 102, thereby eliminating the need for the wireless interface 202. In the illustrated embodiment, the auxiliary audio output device 108 is coupled to a housing 204 of the remote control 200. The illustrated remote control 200 further includes an audio guide (AG) key 206 for invoking aural presentation of a program guide, and a “select” key 207, keypad 208, and arrow keys 210 for navigating the aural program guide in accordance with certain embodiments of the present invention. In addition, the illustrated remote control 200 further includes a microphone 212 for receiving aural navigation instructions from a user in accordance with certain other exemplary embodiments of the present invention.

FIG. 3 depicts a flow chart 300 for use in describing steps associated with the set-up and navigation of an aural program guide in accordance with an exemplary embodiment of the present invention. At block 302, a configuration mode is selected. For example, the configuration mode may be selected when a user depresses a program guide key on a remote control, e.g., audio guide key 206 (FIG. 2). In certain exemplary embodiments, the configuration mode is selected the first time the program guide is accessed and thereafter is selected in response to a particular sequence of key strokes, e.g., depressing the program guide key twice within a predetermined period of time. When the configuration mode is accessed, processing proceeds to blocks 304 and 306 to respectively configure the audio and video aspects of the system.

At block 304, the audio portion of the program guide is configured. In an exemplary embodiment, an aural instruction, e.g., a voice, prompts the user to “make an audio selection.” Assuming an audio system having a primary audio output device and an auxiliary audio output device with four modes of operation, the user may, for example, first hear “audio auxiliary?.” Secondly, the user may hear “audio primary?.” Thirdly, the user may hear “both auxiliary and primary?.” Fourthly, the user may hear “audio off?.” The user may select one of the modes using a selection device such as a remote control 200 (FIG. 2), e.g., by depressing the select key 207 (FIG. 2) immediately after hearing the specific configuration mode announced. The selected configuration may be announced again, thereby confirming a user's selection. If the first mode is selected, the program guide is aurally presented from the auxiliary audio output device only. If the second mode is selected, the program guide is aurally presented from the primary audio output device only. If the third mode is selected, the program guide is aurally presented from both the auxiliary and the primary audio output device. If the fourth mode is selected, the program guide is not presented from either audio output device.

At block 306, the video portion of the program guide is configured. In an exemplary embodiment, an aural instruction, e.g., a voice, prompts the user to “make a video selection.” Assuming one video output device with two modes of operation, the user may, for example, first hear “video on?.” Secondly, the user may hear “video off?.” Using a selection device such as a remote control 200 (FIG. 2) the user may select the first or second configuration by pressing the select key 207 immediately after hearing the specific configuration announced. The selected configuration may be announced again, thereby confirming a user's selection. Processing then proceeds to block 308.

In certain exemplary embodiments, the system has a default setting for presenting program guide information. For example, the system may be set to present initially the program guide aurally at all audio output devices and visually at a video output device, which the user may update during the initial configuration and subsequent reconfigurations of the system.

At block 308, after the video configuration at block 306 or when a program guide signal is received after an initial configuration, processing proceeds to block 310 to allow a user to navigate through the program guide content using a selection device such as a remote control. In an exemplary embodiment, one of several options for navigating through program guide content may be selected. The options may include current time, date, search, or other such option. The options may be presented to the user in sequence, with pauses between sequences. For example, the user may first hear “current time?”. The user may select the current time option by pressing the select key 207 (FIG. 2) on the remote control. The audio may then announce the following: 10:00 p.m. (brief pause), Channel 2-CNN Larry King Live (brief pause), Channel 3-Fox Baseball, Red Sox vs. Yankees (brief pause), Channel 4-(and so on). Accordingly, the audio may sequence through every program offered at 10:00 p.m. Next, the audio may sequence through every program offered at 10:30 p.m. (and so on). The user may select a channel by pressing the select key 207 during the announcement of that channel or in the following brief pause.

The user may interrupt the sequence at any time by simply pressing an arrow key (for example) on the remote control. With no interruption from the user, the program guide may continue announcing in sequence all the viewing possibilities until the list of offerings is complete, wrapping from 10:00 p.m. to 10:30 p.m., then to 11:00 p.m., etc. Upon pressing the up-arrow key, the user may command the program guide to interrupt the audio output. Upon pressing the up-arrow key again, the program guide may be commanded to resume the audio output, picking up at the place of interruption.

The user may command the audio output to skip and begin at the next time slot (for example 10:30 p.m.) by pressing the up-arrow key twice in quick succession. The user may command the audio output to begin at the next day by pressing the up-arrow key three times in quick succession. After a quick pause, the voice may continue announcing the list of offerings available at that date, time and channel.

The user may command the audio output to begin at a previous time slot or a previous date by pressing the down-arrow key twice in quick succession or three times in quick succession, respectively.

The user may hear “date?” after first hearing “current time?”. The user may select the date option, by pressing the select key 207 (FIG. 2) on the remote control. The audio may then begin announcing the viewing possibilities starting at a specific date and time. For example, the audio output may announce the following: Oct. 1, 10:00 p.m. (brief pause), Channel 2-CNN Larry King Live (brief pause), Channel 3-movie, Dracula Meets Jerry Springer (brief pause), Channel 4-(and so on). The user may continue navigating through the program guide content and select channels in a manner similar to that described for the current time option.

From the above-described examples, the implementation for other navigation options, e.g., the search option will be readily apparent to those of skill in the art. It will be appreciated that the steps described above with reference to blocks 302-310 may vary widely according to desired implementation.

Referring back to FIG. 1, in an exemplary embodiment, the apparatus 100 (FIG. 1) is capable of presenting program guide content visually on a video output device 148, aurally on a primary audio output device 140, aurally on an auxiliary audio output device 108, or through a combination thereof.

In an exemplary use, a first viewer and a second viewer watch a video program having a video component and an audio component. Both viewers watch the video component on a video output device 148 such as a television. The first viewer listens to the audio component corresponding to the video component on the primary audio output device, e.g., a pair of speakers coupled to the television. The second viewer requests the program guide (which was previously configured for aural presentation only on the auxiliary audio output device only) and listens to the program guide on the auxiliary audio output device 108, e.g., a wireless headset. The second viewer may then navigate through the program guide using a remote control (for example). Thus, the second viewer can receive the program guide, and navigate through it, aurally without disrupting the audio component or the video component of the program presented to the first viewer. In addition, this exemplary use has the added benefit of helping visually impaired viewers to be more independent while browsing television channels.

In an alternative exemplary use, a first listener and a second listener are listening to an audio component from a compact disc (CD) playing on a CD player. The first listener listens to the audio component on the primary audio output device, e.g., a pair of speakers coupled to a television. The second listener requests the program guide (which was previously configured for aural presentation only on the auxiliary audio output device only) and listens to the program guide on the auxiliary audio output device 108, e.g., a wireless headset. Thus, the second listener can receive the program guide aurally without disrupting the audio component presented to the first listener. In addition, since the program and the program guide are both presented aurally, the program and program guide can be provided without the use of a video display.

While particular embodiments of the present invention have been shown and described in detail, adaptations and modifications will be apparent to one skilled in the art. Such adaptations and modifications of the invention may be made without departing from the scope thereof, as set forth in the following claims.

We claim:

1. A method for presenting program guide content:
receiving at a receiver a program guide and a program having an audio component, the receiver configured to couple to at least two audio output devices;
applying the audio component for presentation at one of the at least two audio output devices; and
applying the program guide for presentation at an other one of the at least two audio output devices concurrently with the aural presentation of the audio component.

2. The method of claim 1, further comprising the step of:
extracting the program guide from a signal;
decoding the extracted program guide to obtain a textual representation of the program guide; and
converting the textual representation of the program guide to an audio format prior to applying the program guide.

3. The method of claim 1, wherein the other one of the at least two audio output devices includes a wireless interface and wherein the method further comprises the step of:
wirelessly transmitting the program guide to the other of the audio output devices.

4. The method of claim 1, further comprising the steps of:
selecting one of the audio component and the program guide for aural presentation at one of the at least two audio output devices; and
selecting the other of the audio component and the program guide for aural presentation at an other one of the at least two audio output devices.

5. The method of claim 1, wherein the program further has a video component and wherein the method further comprises the step of:
applying the video component for display on a video output device concurrently with the aural presentation of the audio component and the program guide.

6. A system for presenting program guide content, the system comprising:
means for receiving, at a receiver, a program guide and a program having an audio component, the receiver configured for coupling to at least two audio output devices;
means for aurally presenting the audio component at one of the at least two audio output devices; and
means for aurally presenting the program guide at an other one of the at least two audio output devices concurrently with the aural presentation of the audio component.

7. The system of claim 6, further comprising:
means for extracting the program guide;
means for decoding the extracted program guide to obtain a textual representation of the program guide; and
means for converting the textual representation of the program guide to an audio format prior to aurally presenting the program guide.

8. The system of claim 6, wherein the other one of the at least two audio output devices includes wireless interface means and wherein the method further comprises:
means for wirelessly transmitting the program guide to the other one of the at least two audio output devices.

9. The system of claim 6, further comprising:
means for selecting one of the audio component and the program guide for aural presentation at one of the at least two audio output devices; and
means for selecting the other of the audio component and the program guide for aural presentation at an other one of the at least two audio output devices.

10. The system of claim 6, wherein the program further has a video component and wherein the system further comprises:
means for visually presenting the video component at a video output device concurrently with the aural presentation of the audio component and the program guide.

11. An apparatus for presenting program guide content, the apparatus comprising:
a receiver configured to receive a program guide and an audio component; and
at least two audio output devices configured to aurally present the program guide and the audio component concurrently, the at least two audio output devices configured to couple to the receiver such that one of the at least two audio output devices aurally presents one of the program guide and the audio component and an other one of the at least two audio output devices aurally presents the other of the program guide and the audio component.

12. The apparatus of claim 11, wherein the receiver comprises at least:
a program guide database;
a decoder that decodes information extracted from the program guide database to obtain a textual representation of the program guide; and
a text-to-speech converter that converts the textual representation of the program guide to an audio format prior to aural presentation of the program guide.

13. The apparatus of claim 11, wherein one of the at least two audio output devices includes at least a wireless interface and wherein the receiver comprises at least:
a wireless transmitter that transmits the program guide to the one of the at least two audio output devices that includes the wireless interface.

14. The appartus of claim 13, wherein the one of the at least two audio output devices is a remote control.

15. The apparatus of claim 11, wherein the receiver comprises at least:
a selection circuit responsive to a selection signal that selects one of the audio component and the program guide for aural presentation at one of the at least two audio output devices and selects an other of the audio component and the program guide for aural presentation at an other one of the at least two audio output devices; and
a switch for producing the selection signal.

16. The apparatus of claim 11, wherein the receiver is further configured to receive a video component corresponding to the audio component, the apparatus further comprising:
a video output device that visually presents the video component concurrently with the audio component, the video output device configured to couple to the receiver.

17. The apparatus of claim 16, wherein the video output device and one of the at least two audio output devices are physically coupled to a common housing and an other one of the at least two audio output devices is physically coupled to a remote housing.

18. An apparatus for presenting program guide content, the apparatus comprising:
a receiver configured to receive a program guide and a program having an audio component and a video component;
at least two audio output devices configured to aurally present the program guide and the audio component concurrently, the at least two audio output devices configured to couple to the receiver such that one of the at least two audio output devices aurally presents one of the program guide and the audio component and an other one of the at least two audio output devices aurally presents the other of the program guide and the audio component; and
a video output device configured to visually present the video component concurrently with the audio component, the video output device configured to couple to the receiver.

19. The apparatus of claim 18, wherein the receiver comprises at least:
a selection circuit responsive to a selection signal that selects one of the audio component and the program guide for aural presentation at one of the at least two audio output devices and selects an other of the audio component and the program guide for aural presentation at an other one of the at least two audio output devices; and
a switch for producing the selection signal.

20. The apparatus of claim 18, wherein the receiver comprises at least:
circuits that extracts the program guide from any of a VBI, out-of-band channel, telephone line, or the Internet;
a decoder that decodes the extracted program guide to obtain a textual representation of the program guide; and
a text-to-speech converter that converts the textual representation of the program guide to an audio format prior to aural presentation of the program guide.

21. An apparatus for presenting program guide content, the apparatus comprising:
a receiver configured to receive a program guide and a program having an audio component and a video component;
a plurality of audio devices responsive to a first selection signal, at least one of the plurality of audio devices selectively configured to aurally present the program guide and at least one other of the plurality of audio devices selectively configured to aurally present the audio component, wherein the program guide and the audio component can be aurally presented from separate ones of the plurality of audio devices concurrently;
a video device responsive to a second selection signal, the video device configured to visually present the video component concurrently with the audio component and selectively configured to visually present the program guide;
a selection circuit responsive to a control signal that produces the first and second selection signals such that the program guide is presented from the at least one of the plurality of audio devices only, the video device only, or both the at least one of the plurality of audio devices and the video device; and
a switch that produces the control signal.
